(19) United States
(12) Patent Application Publication
(10) Pub. No.: US 2004/0031670 A1
(43) Pub. Date: Feb. 19, 2004

(54) Method of actuating a high power micromachined switch

(76) Inventor: Marvin Glenn Wong, Woodland Park, CO (US)

Correspondence Address: AGILENT TECHNOLOGIES, INC., Legal Department. DL429, Intellectual Property Administration, P.O. Box 7599, Loveland, CO, 80537-0599, US

(21) Appl. No.: 10/004,034

(22) Filed: Oct. 31, 2001

(51) Int. Cl. H01H 57/00

(52) U.S. Cl. 200/181

(57) ABSTRACT

In accordance with the invention a method is provided to allow the moveable signal path plate of a MEMS switch to separate from the fixed signal path plate and open the signal path. A solid-state switch is provided in parallel with the MEMS switch. In operation, the MEMS switch is used for good signal transmission and the solid state switch is only used to open the MEMS switch. As a result, the solid state switch needs to have a low capacitance so it does not appreciably affect the signal transmission. Further, the solid state switch needs to have high power handling capacity, i.e. low resistance, but it is not required that it have good signal transmission qualities.

### BACKGROUND

Electrostatically actuated micromachined high-power switches pass electrical signals capacitively. This is done because passing electrical signals by metal to metal contact in a high power environment results in microwelding of the contacts. Electrostatic actuation to close switch contacts is generally achieved by creating a voltage difference on a fixed actuation plate which attracts a moveable actuation plate. The moveable actuation plate is generally attached to a cantilever beam or a beam that is fixed on both ends. The attraction of the actuation plates causes the beam to deflect and places a signal path moveable plate against a dielectric layer covering a signal path fixed plate. The increased proximity of the signal path plates allows a capacitive coupling between the signal path plates which allows passage of a signal and power.

When it is desired to break a capacitive connection, or to “open a switch” the voltage is generally removed from the fixed actuation plate. Thus relieves the electrostatic attraction between the moveable beam and the fixed support structure and allows the beam to return to an undeflected position. In the undeflected position, the signal path plates separate and the capacitive coupling is broken.

In a high power application, as soon as the signal path plates separate slightly, there is a voltage difference induced between the plates that is sufficiently strong to attract the plates back into contact with each other or into close proximity. In such a state, the switch is prevented from opening.

### SUMMARY

The present invention is directed to a microelectromechanical system (MEMS) actuator assembly. Moreover, the present invention is directed to an actuator assembly and method for actuating a MEMS switch in a high power environment.

In accordance with the invention, a method is provided to allow the moveable signal path plate of a MEMS switch to separate from the fixed signal path plate and open the signal path. A solid-state switch is provided in parallel with the MEMS switch. In operation, the MEMS switch is used for good signal transmission and the solid state switch is only used to open the MEMS switch. As a result, the solid state switch needs to have a low capacitance so it does not appreciably affect the signal transmission. Further, the solid state switch needs to have high power handling capacity, i.e. low resistance, but it is not required that it have good signal transmission qualities.

The method of the invention is used in the following manner: The MEMS switch is closed for signal transmission. When it is desired to open the MEMS switch, the solid state switch is closed and the actuation voltage removed from the MEMS switch. Closing the solid state switch allows the voltage to be the same on both the fixed and moveable signal path plates of the MEMS switch, thus allowing the MEMS switch to properly open. The solid state switch is turned off, opening the circuit.

### DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 shows a cross sectional side view of a MEMS switch in accordance with the invention.

FIG. 2 shows a side view of an alternative embodiment of a MEMS switch in accordance with the invention.

FIG. 3 shows a schematic diagram of the solid state switch in parallel with the MEMS switch in accordance with the invention.

### DETAILED DESCRIPTION OF THE INVENTION

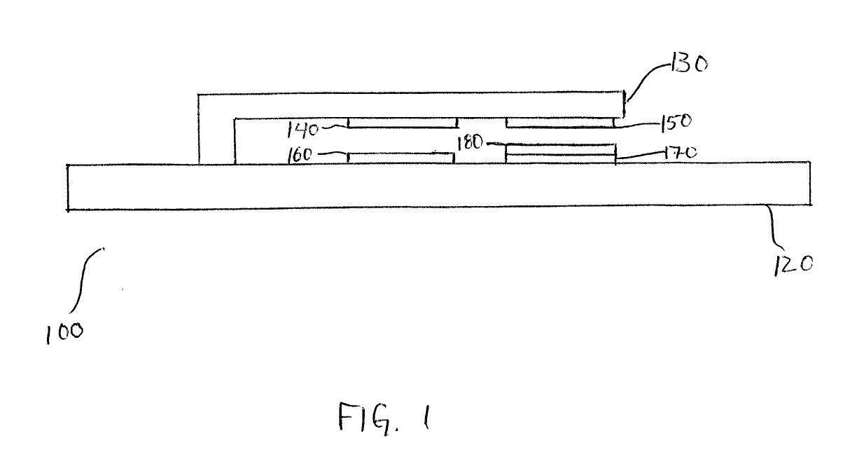

The MEMS switch 100 shown, shown in FIG. 1, includes a substrate 120 which acts as support for the switching mechanism and provides a non-conductive dielectric platform. The MEMS switch 100 shown in FIG. 1 also includes deflecting beam 130 connected to the substrate 10. In common fashion, the deflecting beam 130 forms an L shape with the short end of the deflecting beam 130 connecting to the substrate. The deflecting beam 130 is constructed from a non-conductive material. The deflecting beam 130 has an attracted plate 140 and a first signal path plate 150 connected to the long leg. An actuator plate 160 is connected to the substrate directly opposing the attracted plate. A second signal path plate 170 is connected to the substrate directly opposing the signal path plate 150.

The cantilever beam 130 shown in FIG. 1 is portrayed for purposes of example. It is understood by those skilled in the art that other types of deflecting beams are possible and commonly utilized in the art. One such deflecting beam is a beam fixed at both ends.

During operation of the MEMS switch shown in FIG. 1, a charge is applied to actuator plate 160 causing attracted plate 140 to be electrically attracted thereto. This electrical attraction causes bending of the deflecting beam 130. Bending of the deflecting beam 130 causes the first signal path plate 150 and the second signal path plate 170 to near each other. The nearness of the first and second signal path plates 150,170 causes capacitive coupling, thus allowing the switch 100 to achieve an “on” state. To turn the switch off, the voltage difference between the actuator plate 160 and the attracted plate 140 is removed and the deflecting beam returns to its undeflected position.

A dielectric pad 180 is commonly attached to one or both of the signal path plates 150,170. A dielectric pad is not shown on the signal path plate 150 in FIG. 1. The dielectric pad prohibits the signal path plates 150,170 from coming in contact during the bending of the deflecting beam. It is understood by those skilled in the art that electrostatically actuated micromachined high-power switches preferably pass the signals capacitively because conduction by metal-to-metal can cause the contacts 150,170 to micro-weld.

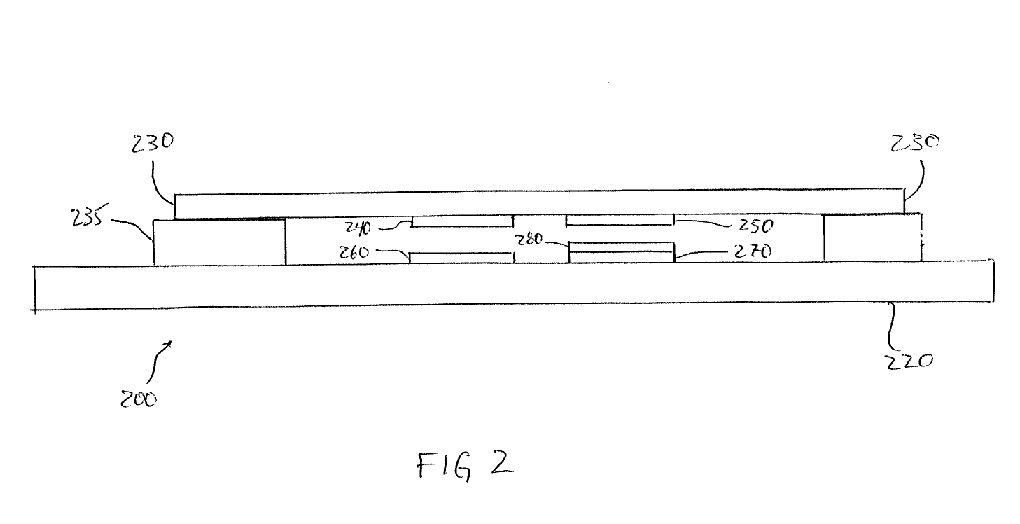

FIG. 2 shows an alternate cross sectional view of a MEMS switch 200 in accordance with the invention. The MEMS switch 200 shown, shown in FIG. 2, includes a substrate 220 which acts as support for the switching mechanism and provides a non-conductive dielectric platform. The MEMS switch 200 shown in FIG. 1 also includes deflecting beam 230 connected which is fixed at each end to a beam support 235. The beam supports 235 are attached to the substrate 220. The deflecting beam 230 is constructed from a non-conductive material. The deflecting beam 230 has an attracted plate 240 and a first signal path plate 250 connected to one side between the supports 235. An actuator plate 260 is connected to the substrate directly opposing the attracted plate. A second signal path plate 270 is connected to the substrate directly opposing the signal path plate 250.

During operation of the MEMS switch shown in FIG. 1, a charge is applied to actuator plate 260 causing attracted plate 240 to be electrically attracted thereto. This electrical attraction causes bending of the deflecting beam 230. Bending of the deflecting beam 230 causes the first signal path plate 250 and the second signal path plate 270 to near each other. The nearness of the first and second signal path plates 250,270 causes capacitive coupling, thus allowing the switch 200 to achieve an “on” state. To turn the switch off, the voltage difference between the actuator plate 260 and the attracted plate 240 is removed and the deflecting beam returns to its undeflected position.

A dielectric pad 280 is commonly attached to one or both of the signal path plates 250,270. A dielectric pad is not shown on the signal path plate 250 in FIG. 2. The dielectric pad prohibits the signal path plates 250,270 from coming in contact during the bending of the deflecting beam. It is understood by those skilled in the art that electrostatically actuated micromachined high-power switches pass the signals capacitively because conduction by metal-to-metal can cause the contacts 250,270 to micro-weld. Further, the high heat present in a high power capacitive MEMS switch can cause annealing of the deflecting beam 230 also resulting in a short circuited MEMS switch.

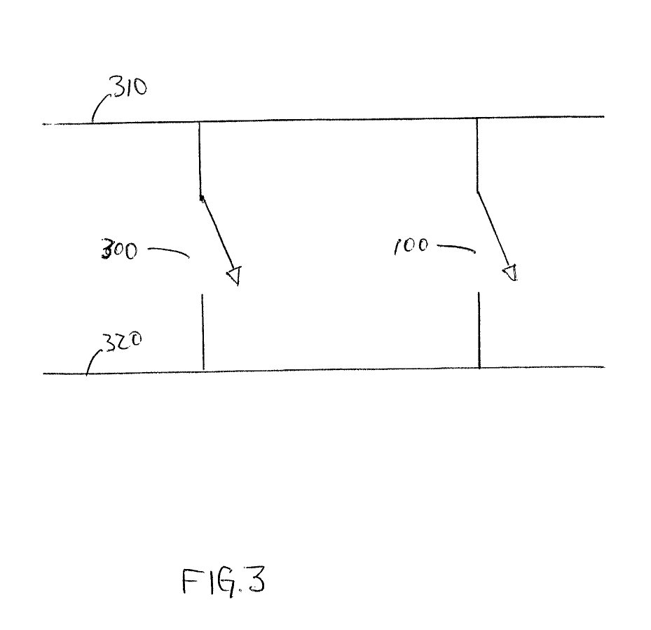

FIG. 3 shows a simplified schematic diagram of a solid state switch 300 in parallel with the MEMS switch 100 of FIG. 1. Both the MEMS switch 100 and the solid state switch 300 pass signals between the signal in path 310 and the signal out path 320. For reference purposes, the signal in path 310 and the signal out path 320 of FIG. 3 connect to the signal path plates 150,170 of FIG. 1.

During operation, the MEMS switch 100 closes and the signal passes from the signal in path 100 to the signal out path 320 when a voltage is applied to the actuator plate 140 of FIG. 1. When it is desired to open the MEMS switch 100, the voltage is removed from the actuator plate 140 of FIG. 1. As previously discussed, a high power environment will cause a voltage differential to develop between the signal path plates 150,170 as they begin to separate (as the deflecting beam returns to the undeflected position). This voltage differential will often be sufficient to cause the signal path plates attract each other and move back into close proximity. The switch cannot open.

In accordance with the invention, the solid state switch 300 of FIG. 3 is closed when the voltage is removed from the actuator plate 140 of FIG. 1. The closure of solid state switch 300 prevents a voltage differential between the signal path plates of the MEMS switch 100. Accordingly, the MEMS switch opens as the deflecting beam 130 of FIG. 1 returns to its undeflected position. When the deflecting beam 130 of FIG. 1 has returned to its undeflected position, the solid state switch is opened. At this point, the signal path plates 150,170 of FIG. 1 are sufficiently distant from each other so that any voltage differential present is not sufficient to deflect the deflecting beam 130.

It is understood by those skilled in the art that the schematic shown in FIG. 3 is merely exemplary of an embodiment of the invention. The solid state switch shown in FIG. 3 can be implemented in parallel with any type of deflecting beam and is not limited to the examples shown here.

While only specific embodiments of the present invention have been described above, it will occur to a person skilled in the art that various modifications can be made within the scope of the appended claims.

What is claimed is:

1. A MEMS switch comprising a deflecting beam attached to a substrate, an actuator plate attached to said substrate, an attracted plate attached to said deflecting beam, a first signal path plate attached to said substrate; a second signal path plate attached to said deflecting beam and a dielectric attached to one of said first or second signal path plates;
wherein said first and second signal path plates are connected to a signal path so that when said first and second signal path plates are in close proximity to each other the signal path closes; and
wherein a solid state switch is in parallel to the MEMS switch and connects to the signal path.

2. The MEMS switch of claim 1 wherein said deflecting beam is a cantilever beam.

3. The MEMS switch of claim 1 wherein said deflecting beam is a beam having a first and second end and said first and second ends are fixed.

4. A method of actuating a MEMS switch, wherein said MEMS switch is a capacitively coupling switch comprising the steps of:
closing the MEMS switch by drawing a pair of signal path plates into close proximity, said close proximity causing the signal path plates to capacitively couple;
opening the MEMS switch by separating said pair of signal path plates and simultaneously closing a solid state switch, said solid state switch being in parallel with said MEMS switch, wherein closing said solid state switch eliminates any voltage differential between the pair of signal path plates; and
allowing the signal path plates to become distant from each other and opening said solid state switch.

5. The method of claim 4, wherein said MEMS switch comprises a deflecting beam attached to a substrate, an actuator plate attached to said substrate, an attracted plate attached to said deflecting beam, a first signal path plate attached to said substrate; a second signal path plate attached to said deflecting beam and a dielectric attached to one of said first or second signal path plates, wherein said step of closing the MEMS switch by drawing a pair of signal path plates into close proximity comprises applying a voltage to said actuator plate.

6. The method of claim 5, wherein said step of opening the MEMS switch by separating said pair of signal path plates comprises removing said voltage from said actuator plate.

7. The method of claim 6 wherein said deflecting beam is a cantilever beam.

8. The method of claim 6, wherein said deflecting beam is a beam with a first and second end and said first and second ends are fixed.
